(19) United States
(12) Patent Application Publication
(10) Pub. No.: US 2020/0267463 A1
(43) Pub. Date: Aug. 20, 2020

(54) HOLDER FOR A LAVALIER MICROPHONE

(71) Applicants: Cameron J. Sinclair, Sechelt (CA); Margaret A. Sinclair, Sechelt (CA)

(72) Inventors: Cameron J. Sinclair, Sechelt (CA); Margaret A. Sinclair, Sechelt (CA)

(21) Appl. No.: 16/279,871

(22) Filed: Feb. 19, 2019

(51) Int. Cl. H04R 1/08; A45F 5/00

(52) U.S. Cl. CPC H04R 1/08; A45F 5/00

(57) ABSTRACT

A holder for holding an electronic device comprising first and second components thereof, such as a lavalier microphone, is provided. The holder includes: (a) a pouch dimensioned for receiving the first component; (b) a strap defining opposing strap ends thereof, the strap being attachable to the pouch at each of the strap ends; and (c) a slider defining opposing slider ends thereof, the slider being slidably attachable to the strap at each of the slider ends, the slider comprising a pocket disposed between the slider ends, the pocket being dimensioned for receiving the second component.

The electronic device may include a cable extending between the first and second components, and the strap may include a plurality of openings dimensioned to receive the cable. The plurality of openings may include at least one perforation. The pouch may include a window. The window may be a mesh window.

### BACKGROUND OF THE INVENTION

### 1. Field of Invention

This invention relates to body-worn containers and, in particular, to a holder for a lavalier microphone.

### 2. Description of Related Art

A lavalier microphone is a body-worn microphone for detecting audio, together with an electrical cable for routing the electrical output signal of the microphone to other audio equipment such as recording equipment, an audio mixer, or the like.

Some lavalier microphones include a body-worn transmitter in wired communication with the body-worn microphone so that the transmitter can wirelessly communicate the audio signal to the other audio equipment. The microphone, transmitter and cable between the microphone and transmitter is typically attached to one's clothing, such as by a clip.

However, clips are cumbersome for performers to use and can require significant set-up time to properly attach the microphone and route the cable between the microphone and transmitter. Costumes worn by performers do not necessarily include convenient attachment points for the microphone, cable, and transmitter. Setting up a lavalier microphone may require a second person to attach the microphone and route the cable between the microphone and transmitter, especially in the case of a child performer.

An object of the invention is to address the above shortcomings.

### SUMMARY

The above shortcomings may be addressed by providing, in accordance with one aspect of the invention, a holder for holding an electronic device comprising first and second components thereof, the holder including: (a) a pouch dimensioned for receiving the first component; (b) a strap defining opposing strap ends thereof, the strap being attachable to the pouch at each of the strap ends; and (c) a slider defining opposing slider ends thereof, the slider being slidably attachable to the strap at each of the slider ends, the slider comprising a pocket disposed between the slider ends, the pocket being dimensioned for receiving the second component.

The pouch may be integrally attached to the strap. The slider may be non-removable coupled to the strap. The electronic device may include a cable extending between the first and second components. The strap may include a plurality of openings dimensioned to receive the cable. The plurality of openings may include at least one perforation. The pouch may include a window. The window may include a mesh.

In accordance with another aspect of the invention, there is provided a method of holding an electronic device having first and second components thereof, the method involving: (a) receiving the first component into a pouch; and (b) receiving the second component into a pocket of a slider when the pocket is disposed between opposing slider ends of the slider, the slider is slidably coupled at its slider ends to a strap defining opposing strap ends thereof, and the strap is attached to the pouch at each of the strap ends.

Receiving the first component into the pouch may involve receiving into the pouch being integrally attached to the strap. The method may involve receiving the second component into the pocket of the slider when the slider is non-removably coupled at its slider ends to the strap. The method may further involve receiving by a plurality of openings of the strap a cable of the electronic device which extends between the first and second components. Receiving by a plurality of openings of the strap a cable of the electronic device may involve receiving by at least one perforation. Receiving the first component into a pouch may involve receiving into the pouch having a window. Receiving into the pouch having the window may involve receiving into the pouch having the window having a mesh.

In accordance with another aspect of the invention, there is provided a holder for holding an electronic device comprising first and second components thereof, the holder including: (a) first receiving means for receiving the first component; and (b) second receiving means for receiving the second component.

The holder may include third receiving means for receiving a cable of the electronic device extending between the first and second components.

The foregoing summary is illustrative only and is not intended to be in any way limiting. Other aspects and features of the present invention will become apparent to those of ordinary skill in the art upon review of the following description of embodiments of the invention in conjunction with the accompanying figures and claims.

### BRIEF DESCRIPTION OF THE DRAWINGS

In drawings which illustrate by way of example only embodiments of the invention:

FIG. 1 is a front view of a holder for an electronic device according to a first embodiment of the invention; and

FIG. 2 is a front view of the holder shown in FIG. 1, showing components of the electronic device being held by the holder.

### DETAILED DESCRIPTION

A holder for holding an electronic device, the electronic device including first and second components thereof, includes: (a) first receiving means for receiving the first component; and (b) second receiving means for receiving the second component. The holder may include third receiving means for receiving a cable of the electronic device extending between the first and second components.

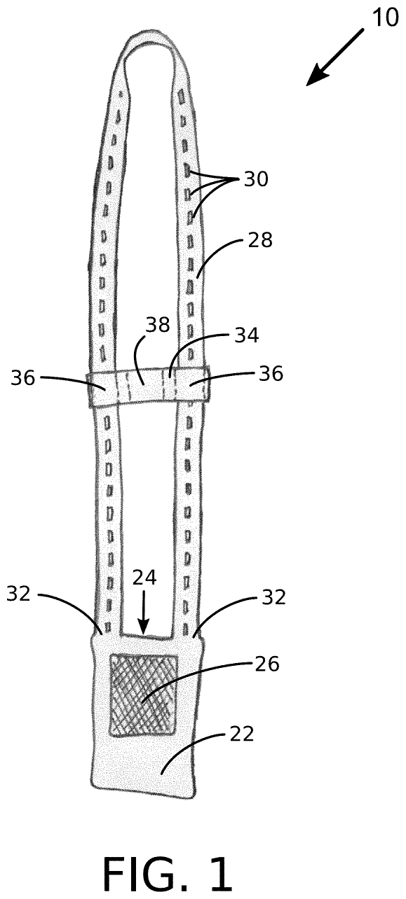

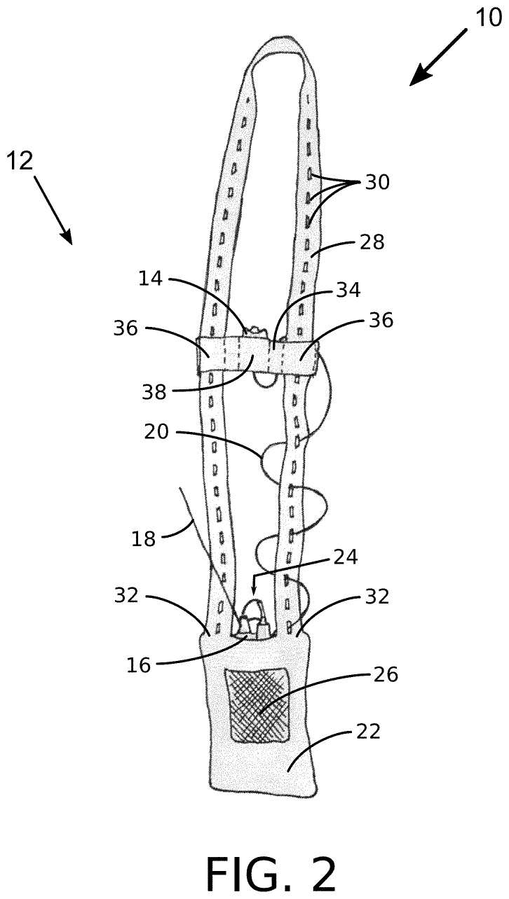

Referring to FIGS. 1 and 2, the holder according to a first embodiment of the invention is shown generally at 10. The holder 10 is operable to hold a lavalier microphone 12, which includes a microphone 14, a transmitter 16 having an antenna 18, and a cable 20 extending between the microphone 14 and the transmitter 16. The microphone 14 need not include a clip or other fastener.

In the first embodiment, the holder 10 includes a pouch 22 defining a primary chamber that is open at its top 24 for receiving the transmitter 16. In the first embodiment, the pouch 22 includes an elastic material so that it can advantageously stretch as needed in response to receiving the transmitter 16 and to respond dynamically to movements of the performer or other user (not shown).

In some embodiments, the pouch 22 defines multiple interior chambers. For example, the pouch may include a secondary chamber (not visible in the figures) for receiving any superfluous length of the cable 20. The secondary chamber may variously be formed by an interior wall within the pouch 22; an additional sleeve on one side, such as the backside or the underneath, of the pouch 22; a flap inside or outside of the primary chamber; a clip, hook or other cable fastener; other formations; or any combination thereof for example.

In some embodiments in which the pouch 22 defines multiple chambers, the pouch 22 is double-chambered (not shown) such that the pouch 22 includes a pair of left and right chambers disposed laterally side-to-side of each other. Additionally or alternatively, the pouch 22 may include front and rear chambers disposed parallel to each other. In use, one chamber may receive the transmitter 16 while other chamber(s) are available for receiving spare component(s) such as one or more of a backup microphone 14, backup transmitter 16, backup cable 20, spare battery (not shown) for the lavalier microphone 12, or other spare component. Additionally or alternatively, one chamber is available to receive a personal recording device in electrical communication, which may be wired or wireless communication, with the transmitter 16 and/or microphone 14.

In both single and multiple chamber configurations of the pouch 22, the pouch 22 may include a left and/or right side opening to provide additional access to any superfluous length of cable 20. In some embodiments, the pouch 22 or a chamber thereof includes a small aperture at the bottom of the pouch 22 to permit upside-down insertion of the transmitter 16 with its antenna 18 projecting downward through the aperture, thereby providing easier access to the battery holder of the transmitter 16 and providing for more convenient battery replacement. Additionally or alternatively, the pouch 22 includes in some embodiments an opening in the bottom of the pouch 22 in which the bottom opening has sufficient size to permit access to the battery holder of a transmitter 16 installed upright in the pouch 22 (as shown in FIG. 2). The bottom opening may be closeable, such as by fastening the bottom opening by a zipper, one or more buttons, a hook-and-loop fastener, a tongue-and-slot fastener, and the like.

In some embodiments (not shown), the pouch 22 includes one or more clips or other fasteners for fastening the pouch 22 to clothing worn by the performer.

The pouch 22 in the first embodiment includes a front window 26 for viewing the transmitter 16 when it is inserted into the pouch 22. The front window 26 may be made of a mesh material as shown in the figures so as to readily permit the pressing of buttons (not visible in the figures) on the transmitter 16. In variations not shown in the figures, the front window 26 may be made of other transparent or translucent materials, or any combination thereof for example. Additionally or alternatively, the pouch 22 and/or its front window 26 may include apertures, windows, and/or other openings (not shown), which may be aligned with buttons (not shown) of the transmitter 16. In some embodiments, a mesh or other window 26 is disposed on both the front and back sides of the pouch 22 so that the holder 10 is advantageously reversible. While the pouch 22 in the first embodiment includes at least one window 26, in general the window 26 is optional and is excluded from some embodiments.

The holder 10 in the first embodiment also includes a strap 28 attached at its opposing ends 32 to the pouch 22. Typically, the strap 28 and the pouch 22 are integrally connected, but in some embodiments (not shown) the strap 28 is removably attachable at one or both strap ends 32. The strap 28 preferably has a sufficient length to permit the holder 10 to be worn around the neck of a performer. In some embodiments, the length of the strap 28 is adjustable. In some adjustable-length embodiments, the strap 28 and/or the pouch 22 includes length-adjustment indicator markings (not shown) to facilitate adjusting the length of the strap 28 relative to the pouch 22 to a pre-determinable adjustment setting.

The strap 28 in the first embodiment includes a plurality of openings such as the perforations 30 shown in the Figures. The perforations 30 advantageously permit the strap 28 to hold the cable 20 at selectable points along the cable 20 by threading the cable 20 through the perforations 30. In general, the perforations 30 may have any suitable size and shape, and any suitable number of perforations 30 may be employed. Typically, the strap 28 does not include perforations 30 midway along the strap 28 where the strap 28 is typically placed against the neck of the performer. Additionally or alternatively to the perforations 30, the openings of the strap 28 may be slits, cut-outs, deformations of the strap 28 material, other cable-retaining features (not shown), or any combination thereof for example.

In some embodiments, the strap 28 includes a tube (not shown) extending along the strap 28 and dimensioned to support the cable 20 at least partway between the microphone 14 and the transmitter 16. In variations, the cable 20 may be supported along the strap 28 by one or more loops, rings, hook-and-loop fastener(s), clip(s), other supportive features, or any combination thereof for example.

In some embodiments, the strap 28 includes a sleeve (not shown) extending along the strap 28 and dimensioned to support the antenna 18. In variations, the antenna 18 may be fastened or otherwise coupled to the strap 28 and/or pouch 22 by one or more loops, rings, hook-and-loop fastener(s), clip(s), tubing, the perforations 30, other coupling techniques, or any combination thereof for example.

In a combination of embodiments, the strap 28 may include a tube or similar for supporting the cable 20 along the strap 28 adjacent one strap end 32 and also includes a sleeve or the like for supporting the antenna 18 along the strap 28 adjacent its other strap end 32.

In some embodiments (not shown), the strap 28 includes one or more clips or other fasteners for fastening the strap 28 to clothing worn by the performer.

The holder 10 in the first embodiment includes a crossbar slider 34 that is slidably coupled to the strap 28 at its opposing slider ends 36. In the first embodiment, the slider 34 forms end 36 loops that circumscribe respective portions of the strap 28. In the first embodiment, the end 36 loops fit snugly to the strap 28 so that the height of the slider 34 along the strap 28 is readily adjustable while still providing sufficient sliding friction to remain at its adjusted height during normal use. In some embodiments, the slider 34 and/or the strap 28 includes fasteners for fastening the slider 34 to an adjustable position along the strap 28.

In some embodiments, the strap 28 and/or the slider 34 includes height-adjustment indicator markings (not shown) to facilitate adjusting the height of the slider 34 relative to the strap 28 to a pre-determinable adjustment setting.

In some embodiments (not shown), the slider 34 includes one or more clips or other fasteners for fastening the slider 34 to clothing worn by the performer.

The slider 34 in the first embodiment includes a pocket 38 situated between the slider ends 36 that is dimensioned for receiving the microphone 14. Typically, the pocket 38 is open-topped as shown in FIG. 2. In the first embodiment, the pocket 38 receives the microphone 14 between two layers of fabric to provide a measure of protection against extraneous noise being received by the microphone 14. Such extraneous noise may come from air movement (e.g. wind) or movement of clothing that comes into contact or near contact with the microphone 14, for example.

In some embodiments, an interior liner is provided within the pocket 38 to further reduce or eliminate extraneous noise from being received by the microphone 14. The interior liner may be made of a thick fabric, such as wool; multiple layers of thin fabric; plastic; rubber; other suitable materials; or any combination thereof for example.

In some embodiments (not shown), the slider 34 includes multiple pockets 38. For example, the slider 34 may include a pair of left and right pockets 38 disposed laterally side-to-side of each other between the slider ends 36. Additionally or alternatively, the slider 34 may include a pair of front and rear pockets 38 parallel to each other. In use, one pocket 38 may receive the microphone 14 while other pocket(s) 38 are available for receiving spare component(s) such as one or more of a backup microphone 14, backup transmitter 16, backup cable 20, spare battery (not shown) for the lavalier microphone 12, or other spare component. Additionally or alternatively, one pocket 38 is available to receive a personal recording device in electrical communication, which may be wired or wireless communication, with the transmitter 16 and/or microphone 14.

In some embodiments (not shown), the slider 34 is size-adjustable, such as being height-adjustable and/or width-adjustable. The slider 34 may include a size-adjustable pocket 38 to advantageously accommodate differently sized microphones 14.

In some embodiments in which the pouch 22 is removably attachable to the strap 28, the slider 34 can be removed and slidably coupled to the strap 28 by sliding the slider 34 off the strap ends 32 whenever the pouch 22 is removed from the strap 28. In some embodiments (not shown), the slider 34 is removably attachable to the strap 28 even without removing the pouch 22 from the strap 28, such as by the slider 34 including a pair of fasteners for opening and closing the pair of loops formed by the slider ends 36, respectively.

In a combination of embodiments (not shown) of the holder 10, both the pouch 22 and the slider 34 are removably attachable to the strap 28. In a variation of such combination, the pouch 22 and the slider 34 may be identically or similarly formed so as to be interchangeable with each other. In such modular variation, differently sized pouches 22 and/or sliders 34 may be available for attaching to the strap 28. In general, any suitable number of interchangeable or non-interchangeable pouches 22 and/or sliders 34 may be installed on the strap 28 for use by the performer.

In some embodiments of the holder 10, the strap 28 is transparent or translucent along its section ordinarily above the slider 34 and below or including around the neck of the performer when in use. This section is where the strap 28 is most likely to be visible and not hidden by clothing worn by the performer. In some embodiments, however, most or all of the holder 10 may be transparent or translucent, such as being made of clear plastic or other transparent or translucent material(s). In some embodiments, all of the holder 10 is transparent except for a non-transparent acoustic liner disposed within the pocket 38.

Thus, there is provided a holder for holding an electronic device comprising first and second components thereof, the holder comprising: (a) a pouch dimensioned for receiving the first component; (b) a strap defining opposing strap ends thereof, the strap being attachable to the pouch at each said strap end; and (c) a slider defining opposing slider ends thereof, the slider being slidably attachable to the strap at each said slider end, the slider comprising a pocket disposed between said slider ends, the pocket being dimensioned for receiving the second component.

### Method of Operation

The holder 10 can be operated by installing the lavalier microphone 12 into the holder 10; and wearing the holder 10.

The lavalier microphone 12 can be installed into the holder 10 by inserting the transmitter 16 into the pouch 22, inserting the microphone 14 into the pocket 38, threading the cable 20 through one or more perforations 30, and connecting opposing ends of the cable 20 to the microphone 14 and the transmitter 16.

The holder 10 can be worn by placing the strap 28 over one's head to situate the mid-section of the strap 28 against the back of one's neck. Typically, the slider 34 and the pouch 22 rest on the front of the torso of the performer under, over or between clothing. The height of the slider 34 can be advantageously adjusted for comfort and/or audio quality.

While embodiments of the invention have been described and illustrated, such embodiments should be considered illustrative of the invention only. The invention may include variants not described or illustrated herein in detail. Thus, the embodiments described and illustrated herein should not be considered to limit the invention as construed in accordance with the accompanying claims.

What is claimed is:

1. A holder for holding an electronic device comprising first and second components thereof, the holder comprising:
(a) a pouch dimensioned for receiving the first component;
(b) a strap defining opposing strap ends thereof, the strap being attachable to the pouch at each said strap end; and
(c) a slider defining opposing slider ends thereof, the slider being slidably attachable to the strap at each said slider end, the slider comprising a pocket disposed between said slider ends, the pocket being dimensioned for receiving the second component.

2. The holder of claim 1 wherein the pouch is integrally attached to the strap.

3. The holder of claim 2 wherein the slider is non-removably coupled at its said slider ends to the strap.

4. The holder of claim 3 wherein the electronic device comprises a cable extending between the first and second components, the strap comprising a plurality of openings dimensioned to receive the cable.

5. The holder of claim 4 wherein the plurality of openings comprises at least one perforation.

6. The holder of claim 3 wherein the pouch comprises a window.

7. The holder of claim 6 wherein the window comprises a mesh.

8. A method of holding an electronic device comprising first and second components thereof, the method comprising:
(a) receiving the first component into a pouch; and
(b) receiving the second component into a pocket of a slider when the pocket is disposed between opposing slider ends of the slider, the slider is slidably coupled at its said slider ends to a strap defining opposing strap ends thereof, and the strap is attached to the pouch at each said strap end.

9. The method of claim 8 wherein receiving the first component into the pouch comprises receiving into the pouch being integrally attached to the strap.

10. The method of claim 9 wherein receiving the second component into the pocket of the slider when the pocket is disposed between said opposing slider ends of the slider, the slider is slidably coupled at its said slider ends to the strap defining said opposing strap ends thereof, and the strap is attached to the pouch at said each strap end comprises receiving when the slider is non-removably coupled at its said slider ends to the strap.

11. The method of claim 10 further comprising receiving by a plurality of openings of the strap a cable of the electronic device extending between the first and second components.

12. The method of claim 11 wherein receiving by a plurality of openings of the strap a cable of the electronic device extending between the first and second components comprises receiving by at least one perforation.

13. The method of claim 10 wherein receiving the first component into the pouch comprises receiving into the pouch comprising a window.

14. The method of claim 13 wherein receiving into the pouch comprising the window comprises receiving into the pouch comprising the window comprising a mesh.

15. A holder for holding an electronic device comprising first and second components thereof, the holder comprising:
(a) first receiving means for receiving the first component; and
(b) second receiving means for receiving the second component.

16. The holder of claim 15 further comprising third receiving means for receiving a cable of the electronic device extending between the first and second components.
